(19) United States
(12) Patent Application Publication
(10) Pub. No.: US 2007/0108780 A1
(43) Pub. Date: May 17, 2007

(54) Automatic side door protector

(76) Inventor: Charles Udolph, Encino, CA (US)

Correspondence Address: CISLO & THOMAS, LLP, 233 WILSHIRE BLVD, SUITE 900, SANTA MONICA, CA, 90401-1211, US

(21) Appl. No.: 11/595,772

(22) Filed: Nov. 10, 2006

Related U.S. Application Data
(60) Provisional application No. 60/735,324, filed on Nov. 12, 2005.

(51) Int. Cl. B60R 19/42

(52) U.S. Cl. 293/128

(57) ABSTRACT

An automatic side door protector comprising a protective pad and a support strap. The support strap is connected to the protective pad at one or more places. The protective pad may be divided into two or more segments which may be folded for compact storage. The automatic side door protector is installed on the vehicle to be protected by pinching the support strap either between a window and the window frame or between the door and the door frame. An enlarged end on the support strap helps to prevent the support strap from being pulled back through the closed window or door. The automatic side door protector is height adjustable by varying the length of the support strap that is pinched off by the window or door.

### CROSS-REFERENCES TO RELATED APPLICATIONS

This patent application claims the benefit of U.S. Provisional Patent Application Ser. No. 60/735,324 filed Nov. 12, 2005 for Door Guard, which application is incorporated here by this reference.

### TECHNICAL FIELD

This invention relates to protective devices that minimize damage to the sides of vehicles from scratches, dings, and dents.

### BACKGROUND ART

It is a frequent occurrence that a vehicle, especially when parked in a parking lot, is subject to being damaged by the doors or occupants of vehicles in adjacent parking spots. Those other occupants may be unaware that their vehicle doors, their shopping carts, or they themselves are causing the other vehicle to be scratched, dinged, dented, or otherwise damaged. As such, there exists a need for a device to protect the doors and sides of vehicles from that damage.

A number of previous devices have been created to address this problem. However, those devices are often cumbersome to use, not adjustable for a variety of vehicles, or not theft resistant. Therefore, there exists a need for a protective device that is lightweight, easy to install onto the vehicle, and easy to store. There also exists a need for a protective device that is easily adjusted to fit a variety of vehicle sizes and that is resistant to being removed from the vehicle by someone other than the vehicle's owner.

### DISCLOSURE OF INVENTION

The present invention is directed to an easy to use, compact device for protecting the sides of a vehicle from damage such as scratches, dings, and dents. The invention provides an automatic side door protector having a protective pad and a support strap. The support strap is connected to the protective pad at one or more places. The protective pad can be divided into two or more segments which can be folded against each other for compact storage. The automatic side door protector is installed on the vehicle to be protected by pinching the support strap either between a window and the window frame or between the door and the door frame. An enlarged end on the support strap helps to prevent the support strap from being pulled back through the closed window or door, the enlarged end being preferably formed by turning an end of the support strap over upon itself at least one time. The automatic side door protector is height adjustable by varying the length of the support strap that is inside of the vehicle when the support strap is pinched by the window or door.

### BRIEF DESCRIPTION OF DRAWINGS

FIG. 1 is a plan view of an embodiment of an automatic side door protector.

FIG. 2 is a side view of the automatic side door protector depicted in FIG. 1.

FIG. 3 depicts an embodiment of an automatic side door protector installed on a vehicle.

FIG. 4 is a plan view of an embodiment of an automatic side door protector.

FIG. 5 is a plan view of an embodiment of an automatic side door protector.

FIG. 6 is a plan view of an embodiment of an automatic side door protector.

FIG. 7 is a side view of a rolled end of an embodiment of an automatic side door protector.

FIG. 8 is a side view of a rolled end of an embodiment of an automatic side door protector.

FIG. 9 is a partial side view of an embodiment of an automatic side door protector, depicting an optional slot mechanism.

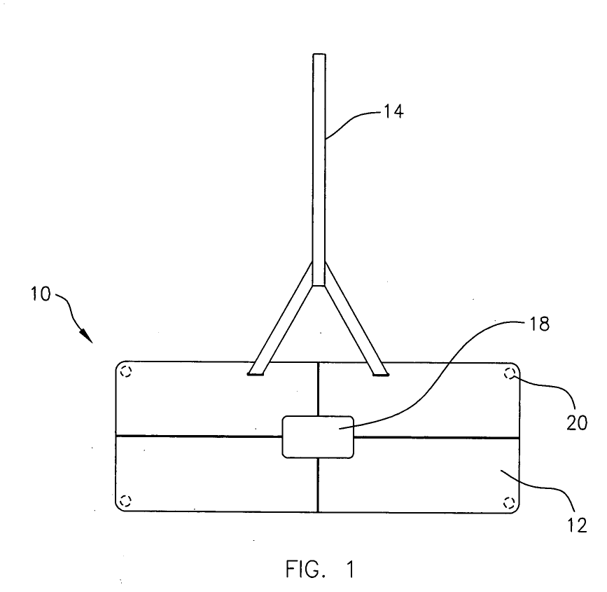

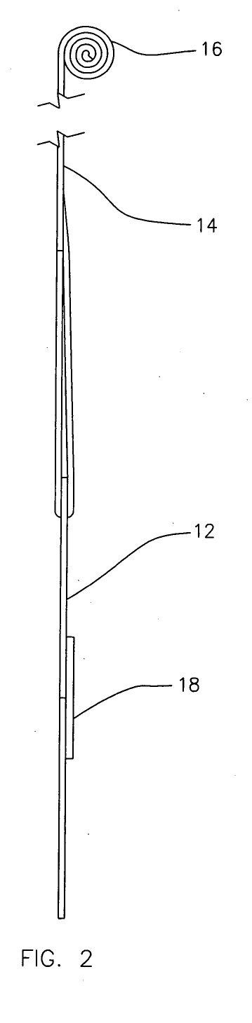

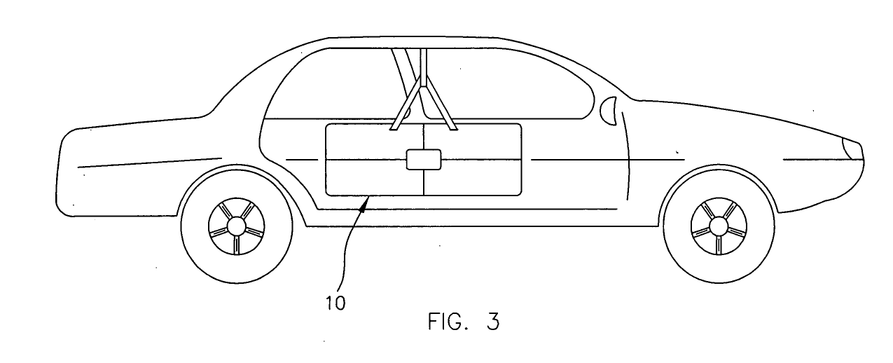

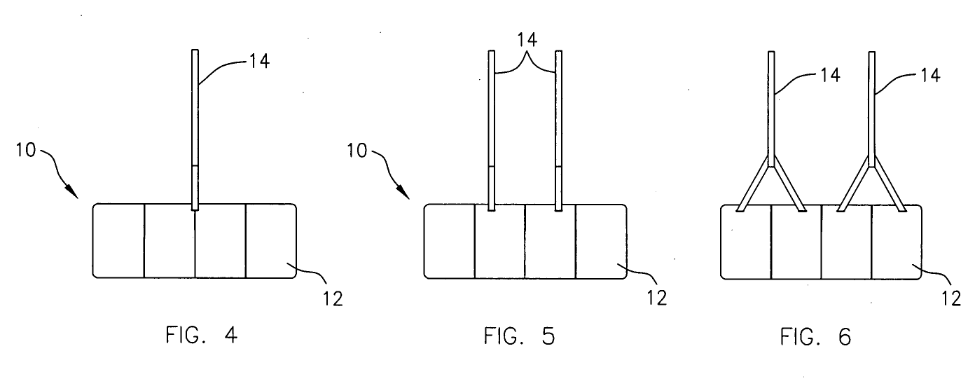

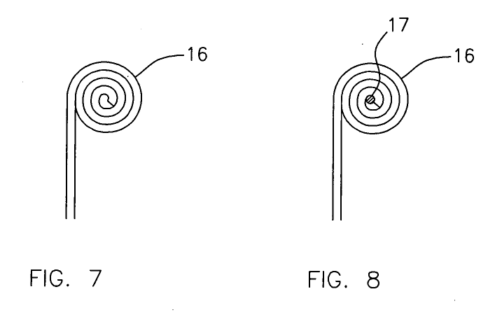

### BEST MODE FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

Referring to the figures, the automatic side door protector 10 has a protective pad 12 and a support strap 14. The support strap 14 is connected to the protective pad 12 at one or more places.

The protective pad 12 is generally planar, may be generally rectangular, and may have rounded corners to minimize wind resistance. In some versions of the invention, the protective pad 12 may be divided into two or more segments. Each of those segments may be pivotally connected to an adjacent segment, permitting the segments to be folded against an adjacent segment. This allows the automatic side door protector 10 to be made compact for storage, for example, in a vehicle's trunk. In some embodiments, the protective pad 12 may have one or more magnets 20 to assist in securing the automatic side door protector 10 to a magnetic surface, such as a vehicle's door. The one or more magnets 20 may be attached to the protective pad 12 or the magnets may be internal to the protective pad 12.

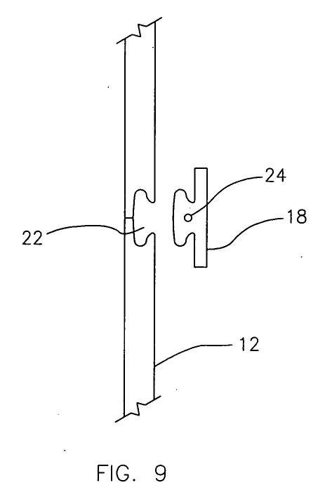

In some embodiments of the invention, the protective pad 12 may have a hub member 18 to increase the rigidity of the protective pad 12, particularly in its unfolded position. The protective pad 12 may further have fasteners, such as snaps, latches, or hook-and-loop fasteners, to connect one or more of the segments of the protective pad 12 to the hub member 18 and help maintain the protective pad 12 in its unfolded position. In an embodiment of the invention, the fastener may comprise a slot mechanism 22 in the protective pad 12 and a corresponding mating portion on the hub member 18, the mating portion fitting within the slot 22. The hub member 18 may further have a reinforcing member 24, such as a metal, wood, rubber, polymeric compound, or plastic rod. Refer to FIG. 9. The reinforcing member 24 provides additional structural integrity to the automatic side door protector 10.

Referring to FIG. 3, the automatic side door protector 10 is installed on the vehicle to be protected by inserting the support strap 14 either between a window and the window frame or between the door and the door frame. The window or door is closed onto the support strap 14, securing it by pinching the support strap 14 between the window and the window frame or between the door and the door frame, respectively. The automatic side door protector 10 is height adjustable by varying the length of the support strap 14 that is inside of the vehicle when the support strap 14 is pinched by the window or door. Where more of the support strap 14 is inside of the vehicle, the protective pad 12 is generally higher up on the side of the vehicle than when less of the support strap 14 is inside of the vehicle. Therefore, the automatic side door protector 10 is adaptable to account for various vehicle types. Further, the structure of the device permits the automatic side door protector 10 to be installed on just one side of the vehicle, if desired. The overall dimensions of an embodiment of the invention permit a single automatic side door protector 10 to protect both doors on one side of the vehicle.

To deter theft of the automatic side door protector 10, the support strap 14 further has an enlarged end 16. The end is enlarged in that its thickness is generally greater than the thickness of the remainder of the support strap 14. The enlarged end 16 helps to prevent the support strap 14 from being pulled back through the closed window or door of the vehicle. The enlarged end 16 can be formed, for example, by rolling, turning, or curling the end of the support strap 14 over itself or by wrapping the support strap 14 around an anchor object 17. The enlarged end may also be formed by attaching an anchor object 17 to the support strap 14, where the width of the anchor object is greater than the thickness of the support strap 14. The anchor object 17 may be of any size or shape, provided the support strap 14 can be wrapped around the anchor object 17 or the anchor object 17 can be attached to the support strap 14, either on the inside or the outside of the end of the support strap 14.

To provide a long-lasting device, in some versions of the invention the protective pad 12 is made of a highly durable material that is resistant to weather, heat, and water. Such materials include, but are not limited to, plastics; laminated wood or cardboard; and felt-covered plastic, metal, wood, and cardboard. Other materials can also be successfully used.

While the present invention has been described with regards to particular embodiments, it is recognized that additional variations of the present invention may be devised without departing from the inventive concept.

### INDUSTRIAL APPLICABILITY

This invention may be industrially applied to the manufacture and use of protective devices that minimize damage to the sides of vehicles from scratches, dings, and dents.

What is claimed is:

1. A device for protecting the sides of a vehicle from damage such as scratches, dings, and dents, the device comprising:
(a) a protective pad, the protective pad being generally planar, the protective pad being divided into a plurality of segments where each of the plurality of segments is pivotally connected to at least one other of the plurality of segments, permitting the device to be folded along the pivotal connection, the protective pad being formed from a weather resistant material; and
(b) a support strap, the support strap being connected to the protective pad at a peripheral edge of the protective pad, the support strap further having a rolled end formed by rolling the end of the support strap over itself one or more times.

2. The protective device of claim 1, the protective pad further comprising at least one magnet for securing the protective device to a magnetic surface.

3. The protective device of claim 1, the protective pad further comprising a hub member, the hub member positioned and dimensioned to increase the rigidity of the protective pad.

4. A vehicle door protector, comprising:
(a) a protective pad, the protective pad having a peripheral edge; and
(b) a support strap, the support strap having an attachment end a enlarged end, the attachment end having a thickness, the attachment end being connected to the peripheral edge of the protective pad, the enlarged end having a thickness that is generally greater than the thickness of the attachment end of the support strap.

5. The vehicle door protector of claim 4, the protective pad further comprising a plurality of pad sections, each pad section being pivotally connected to another pad section.

6. The vehicle door protector of claim 5, the protective pad further comprising a hub member, the hub member positioned and dimensioned to increase the rigidity of the protective pad.

7. The vehicle door protector of claim 6, the protective pad further comprising one or more fasteners to connect one or more of the plurality of pad sections to the hub member.

8. The vehicle door protector of claim 7, the one or more fasteners comprising a slot and a corresponding projection, the projection shaped and dimensioned to fit within the slot to connect one or more of the plurality of pad sections to the hub member.

9. The vehicle door protector of claim 8, the slot being located on the one or more of the plurality pad sections, the projection being located on the hub member, the hub member further comprising a reinforcing member to provide additional structural integrity to the vehicle door protector.

10. The vehicle door protector of claim 9, the reinforcing member comprising a rod being made from a material selected from the group consisting of: plastic, rubber, polymeric compound, wood, and metal.

11. The vehicle door protector of claim 4, the enlarged end of the support strap being formed by turning the enlarged end of the support strap upon itself at least one time.

12. The vehicle door protector of claim 4, the enlarged end of the support strap comprising an anchor object around which the enlarged end is turned.

13. The vehicle door protector of claim 4, the enlarged end of the support strap comprising an anchor object attached to the support strap.

14. The vehicle door protector of claim 4, the attachment end of the support strap comprising a plurality of branches, each branch being attached to the peripheral edge of the protective pad.

15. The vehicle door protector of claim 4 further comprising a plurality of support straps connected to the protective pad.

16. The vehicle door protector of claim 4, the protective pad being generally rectangular and having generally rounded corners.

17. The vehicle door protector of claim 4, the protective pad further comprising at least one magnet for securing the vehicle door protector to a magnetic surface.

18. The vehicle door protector of claim 4, the protective pad being made from a durable, weather resistant material.

19. The vehicle door protector of claim 18, the durable, weather resistant material being selected from the group consisting of: plastic, rubber, polymeric compound, laminated wood, laminated cardboard, felt-covered metal, felt-covered wood, and felt-covered cardboard.

20. A method of protecting a door of a vehicle and of deterring theft of a vehicle door protector, comprising the steps of:
(a) providing a vehicle door protector, the vehicle door protector having:
i. a protective pad, the protective pad having a peripheral edge; and
ii. a support strap, the support strap having an attachment end a enlarged end, the attachment end being connected to the peripheral edge of the protective pad, the enlarged end of the support strap being formed by turning the enlarged end of the support strap over itself at least one time;
(b) mounting the vehicle door protector to the vehicle by:
i. opening a window or a door of the vehicle;
ii. feeding the enlarged end of the support strap through the vehicle's open window or over an edge of the open door, the protective pad of the vehicle door protector remaining outside of the vehicle, generally parallel to a side of the vehicle;
iii. closing the vehicle's window or the vehicle's door so that the support strap is pinched between the vehicle's window and a window frame or between the vehicle's door and a door frame, respectively, the enlarged end being inside of the vehicle and the protective pad of the vehicle door protector hanging outside of the vehicle from the pinched support strap, the enlarged end of the support strap helping to prevent the support strap from being pulled back through the closed window or door of the vehicle.

21. The method of claim 20, further comprising the step of, prior to closing the vehicle's window or the vehicle's door, increasing or decreasing a length of the support strap that is fed through the vehicle's open window or over the edge of the open door such that the protective pad of the vehicle door protector, hanging from the support strap, may be accurately positioned on the outside of the vehicle.

22. The method of claim 20, the enlarged end of the provided support strap being formed by turning the enlarged end of the support strap over upon itself at least one time.

23. The method of claim 20, the enlarged end of the provided support strap being formed by attaching an anchor object to the support strap.
